(19) United States
(12) Patent Application Publication
(10) Pub. No.: US 2013/0255579 A1
(43) Pub. Date: Oct. 3, 2013

(54) PET TREAT DISPENSER

(71) Applicant: Susan D. Sharpe, Huntington, IN (US)

(72) Inventor: Susan D. Sharpe, Huntington, IN (US)

(21) Appl. No.: 13/893,738

(22) Filed: May 14, 2013

Related U.S. Application Data
(63) Continuation-in-part of application No. 12/413,513, filed on Mar. 27, 2009.
(60) Provisional application No. 61/039,853, filed on Mar. 27, 2008.
(60) Provisional application No. 61/647,309, filed on May 15, 2012.

(51) Int. Cl. A01K 5/00

(52) U.S. Cl. CPC A01K 5/00
USPC 119/51.01

(57) ABSTRACT

A pet treat dispenser including a housing, a power source, a controller, and a shooting mechanism. The housing has a treat chamber containing a plurality of treats. The controller is configured to issue a signal to release a treat. The at least one shooting mechanism is positioned in the housing. The shooting mechanism can sequentially shoot treats from the dispenser. The shooting mechanism includes an energy imparting device coupled to the power source. The energy imparting device imparts movement to a selected subset of the plurality of treats dependent upon receiving the signal from the controller.

### CROSS REFERENCE TO RELATED APPLICATIONS

This is a continuation-in-part of U.S. patent application Ser. No. 12/413,513 entitled “PET TREAT DISPENSER”, filed Mar. 27, 2009, which is incorporated herein by reference, which is a non-provisional application based upon U.S. provisional patent application Ser. No. 61/039,853, entitled “TREAT RELEASE”, filed Mar. 27, 2008. This application is also based upon U.S. provisional patent application Ser. No. 61/647,309, entitled “PET TREAT DISPENSER”, filed May 15, 2012, which is incorporated herein by reference.

### BACKGROUND OF THE INVENTION

1. Field of the Invention

The present invention relates to a pet treat dispenser, and, more particularly, to a pet treat dispenser activated by the pet.

2. Description of the Related Art

The human/animal dependency on each other predates historical record. Mankind has utilized animals in various ways including befriending and using animals as an extension of their own management of other animals, such as the use of dogs to herd animals. The modification of behavior of animals has a long history as well and includes various forms of positive and negative reinforcement techniques utilized in order to manipulate and/or solicit a desired behavior from the animal. For example, behavior modification collars are utilized by some to modify the behavior of the animal and/or to report the animal's location. It is well-known to utilize food treats to modify the behavior of animals as a reward for desired behavior.

The military has utilized pigeons as a munitions-guiding technique when a target was presented on a screen, pigeons would peck at the selected silhouette and would be rewarded with pieces of grain for performing the task. Primates have been trained to recognize sequential patterns and respond to displays on a computer screen in manners that results in a food reward. It is also known to utilize a food-release mechanism that is timed so that the feeding of an animal is based on a schedule programmed by the device's user.

What is needed in the art is a dispenser that will function as a toy yet reward an animal, such as a dog, when the dog has performed at least one sequential task in order to gain the treat.

### SUMMARY OF THE INVENTION

The invention is directed to a pet training device, and more particularly to a pet treat dispenser that is at least partially activated by the pet.

The invention in one form is directed to a pet treat dispenser including a housing, a power source, a controller, and a shooting mechanism. The housing has a treat chamber containing a plurality of treats. The controller is configured to issue a signal to release a treat. The at least one shooting mechanism is positioned in the housing. The shooting mechanism can sequentially shoot treats from the treat chamber. The shooting mechanism includes an energy imparting device coupled to the power source. The energy imparting device imparts movement to a selected subset of the plurality of treats dependent upon receiving the signal from the controller.

The invention in another form is directed to a pet treat dispenser including a power source, a controller, and a shooting mechanism. The controller is configured to issue a signal to release a treat. The shooting mechanism including an energy imparting device coupled to the power source. The energy imparting device is configured to impart movement to a selected treat dependent upon receiving the signal from the controller.

An advantage of the present invention is that it releases a treat and re-arms to release a subsequent treat.

Another advantage of the present invention is that it allows for the storage of numerous treats so that reloading is minimized.

Yet another advantage of the present invention is that it selects which treat firing mechanism is used to project the treat.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 is a top view of an embodiment of a treat dispenser of the present invention;

FIG. 2 is a schematic side view of the treat dispenser of FIG. 1;

FIG. 3 is a partially sectioned view of a shooting mechanism of FIGS. 1 and 2;

FIG. 4 is a top view of another embodiment of a pet treat dispenser of the present invention;

FIG. 5 is a side exploded view of the pet treat dispenser of FIG. 4;

FIG. 6 is a perspective segmented view of a lower portion of the pet treat dispenser of FIGS. 4 and 5;

FIG. 7 is a schematized bottom view of the pet treat dispenser of FIGS. 4-6; and

FIG. 8 is a functional diagram of the pet treat dispenser of FIGS. 4-7.

Corresponding reference characters indicate corresponding parts throughout the several views. The exemplifications set out herein illustrate one embodiment of the invention, in one form, and such exemplifications are not to be construed as limiting the scope of the invention in any manner.

### DETAILED DESCRIPTION OF THE INVENTION

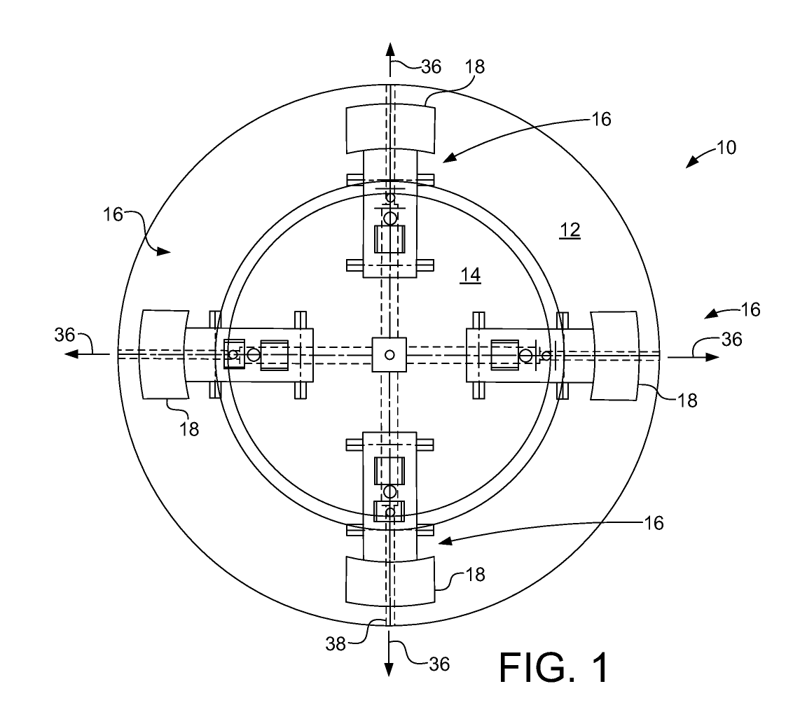

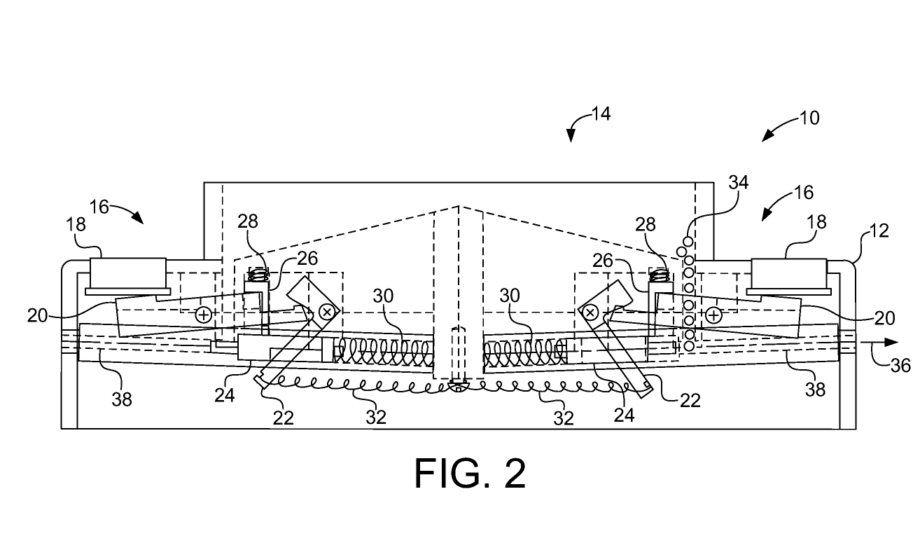

Referring now to the drawings, and more particularly to FIGS. 1-3, there is shown a treat shooter 10, also known as a treat dispenser 10, having a housing 12, a treat chamber 14 and a shooting mechanism 16. Shooting mechanism 16 includes a pad 18, a lever 20, a return lever 22, a plunger 24, a latch 26, a latch spring 28, a plunger spring 30, and a return lever spring 32. FIG. 2, illustrates two firing mechanisms 16, the left mechanism has fired and dispelled a treat by way of barrel 38 with plunger 24 being shown in a released position. Plunger 24 in the right mechanism 16 has just been released and is shown in its ready position before being moved by way of plunger spring 30 into the released position.

Pad 18 normally extends above the housing when shooting mechanism 16 is in an armed position. An extended boss around one end of pad 18 prevents pad 18 from passing completely through the opening in housing 12 that accommodates pad 18. Lever 20, also known as a pivot arm 20, is pivoted about a pivot point and comes into contact with pad 18 when pad 18 is depressed thereagainst one portion of lever 20. Although not show, lever 20 may additionally have a biasing element to place it in a preferred position. Return lever 22 is pivoted about another pivot point and engages a back extension of plunger 24 when plunger 24 is being reset by return lever 22.

As shown in FIG. 2, return levers 22 are moved to a position so that they will not interfere with the movement of plunger 24 from a ready position to released position. The movement of return lever 22 is affected by the contact of a portion of lever 20 that moves return lever 22 and also contacts latch 26. Latch 26 is held in a down position by virtue of compressed biasing element 28, also known as latch spring 28. Movement of lever 20 moves latch 26 along with return lever 22. Return lever 22 may be positioned relative to lever 20 so that movement of return lever 22 precedes the contact of lever 20 with latch 26, to thereby ensure that return lever 22 is in a non-interfering position prior to latch 26 being moved to release plunger 24 so that it may plunge forward and shoot a treat 34 down barrel 38 along a treat path 36. As can be seen in FIG. 2, latch 26 and return lever 22 are separate assemblies and are not directly connected to each other.

Pad 18 which had been depressed by the paw or snout of a dog is released, allowing pad 18 to move vertically as lever 20 pivots about its pivot point which may be partially moved as a result of the depression of latch spring 28 and the tension of return lever spring 32. The energy stored in return spring 32, by virtue of the depressing of pad 18, is then used to overcome the biasing force of plunger spring 30 to reset plunger 24 back to a ready position and latch 26 is spring-loaded to then interfere with a front portion of plunger 24, thereby re-arming shooting mechanism 16. The combination of plunger 24 and plunger spring 30 can be understood to be a biased mechanism that is fired by the movement of latch 26. It may be noted that return lever 22 may hold plunger 24 in its ready position until it is moved forward away from plunger 24 when lever 20 is being depressed, allowing the front edge of plunger 24 to contact latch 26 which, when lever 20 is fully depressed, causes latch 26 to be moved away from plunger 24, thereby firing plunger 24 and moving it to a released position.

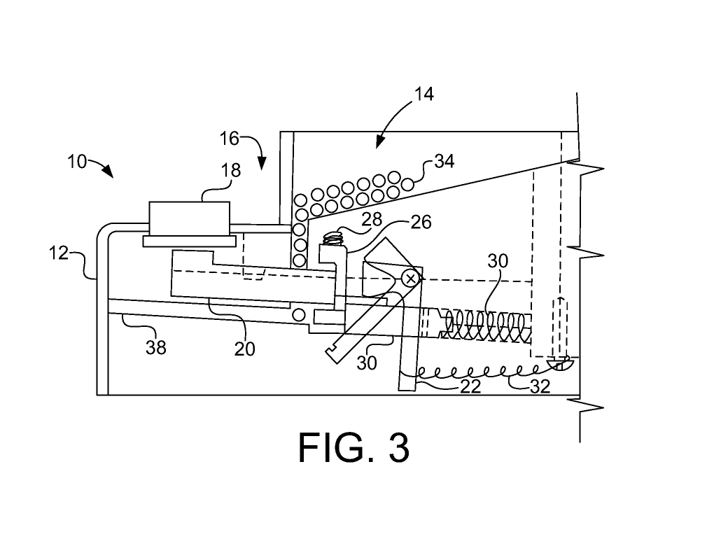

In utilizing treat shooter 10, treats 34 are loaded into treat chamber 14, which has an angled inner surface to thereby persuade the treats by the forces of gravity to enter the vertical loading channel that direct the treats in a one-by-one sequence into barrel 38 for each sequential firing of shooting mechanism 16. The shape of the treats is depicted as being spherical in nature but other shapes are also contemplated. For ease of understanding, plunger 24 may be thought of as being similar to a pinball plunger and treats 34 as the ball utilized in a pinball machine. As previously described, pad 18 is pressed down onto lever 20 urging return lever 22 to be moved about its pivot point and also sequentially lifting latch 26 to fire plunger 24. Once a treat 34 is expelled along treat path 36 from barrel 38, the release of pad 18 causes shooting mechanism 16 to reset. As can be seen in FIG. 3, return lever 22 has moved plunger 24 to its ready position and shooting mechanism 16 is in an armed condition awaiting the pressing of pad 18.

A lid, not shown, is placed over the top of housing 12 covering treat chamber 14 so that the pet cannot simply feed from the top of treat shooter 10. Advantageously, several shooter mechanisms 16 may be positioned about treat shooter 10. Although treat chamber 14 is illustrated as one chamber, there may be multiple chambers 14 allowing separate treats to be positioned in each quadrant of treat shooter 10 so that different flavored treats may be shot from the separate shooting mechanisms 16. This advantageously allows treat shooter 10 to not only be used as a treat dispensing mechanism but allows for the testing of the popularity of separately flavored treats with the dog presumably being enticed to distinguish from each of the treat shooters which flavor is preferred. Advantageously, treat shooter 10 functions entirely by way of the energy supplied by the pet so that no outside energy source is needed to arm or fire mechanisms of shooting mechanism 16.

Now, additionally referring to FIGS. 4-8, there is illustrated a treat shooter 110, also known as a treat dispenser 110, having a housing 112, a treat chamber 114 and a shooting mechanism 116. Shooting mechanism 116 includes an actuator pad 118 (also known as a sensor 118), a barrel 138, a function selector 150, a controller 152, a remote control 154, a battery 156, an AC power connection 158, a clean out bin 160, an energy imparting device 162, and solar cell 164. Applicable details from the above embodiment are also pertinent to these elements where the reference numbers have 100 added to them.

It is understood that remote control 154 may be a host of devices that interact with treat shooter 110, such as an iPad, a cell phone, a smart phone, a computer or any other remote device capable of triggering an action.

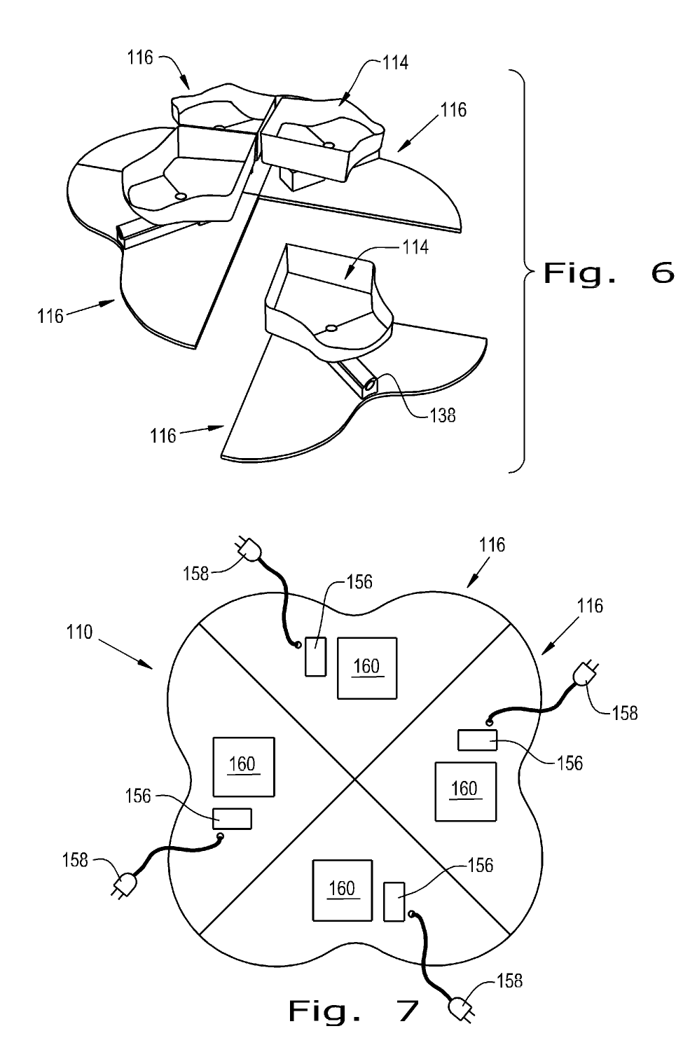

Each shooting mechanism 116 is modularized as shown in FIG. 6, with a treat chamber 114 feeding a selected subset of the treats, which may be just one treat placed therein, to the energy imparting device 162 associated with each shooting mechanism 116. Energy imparting device 162 is an electrical device, such as a solenoid that is activated under the control of controller 152 to impart motion to a treat and shoot it out barrel 138. The movement of the treat may be by way of physical contact with the treat or by way of an intermediate mechanism such as air pressure released or generated by movement of the plunger of the solenoid, causing air pressure to propel the treat. Energy imparting device 162 is connected to an end of barrel 138.

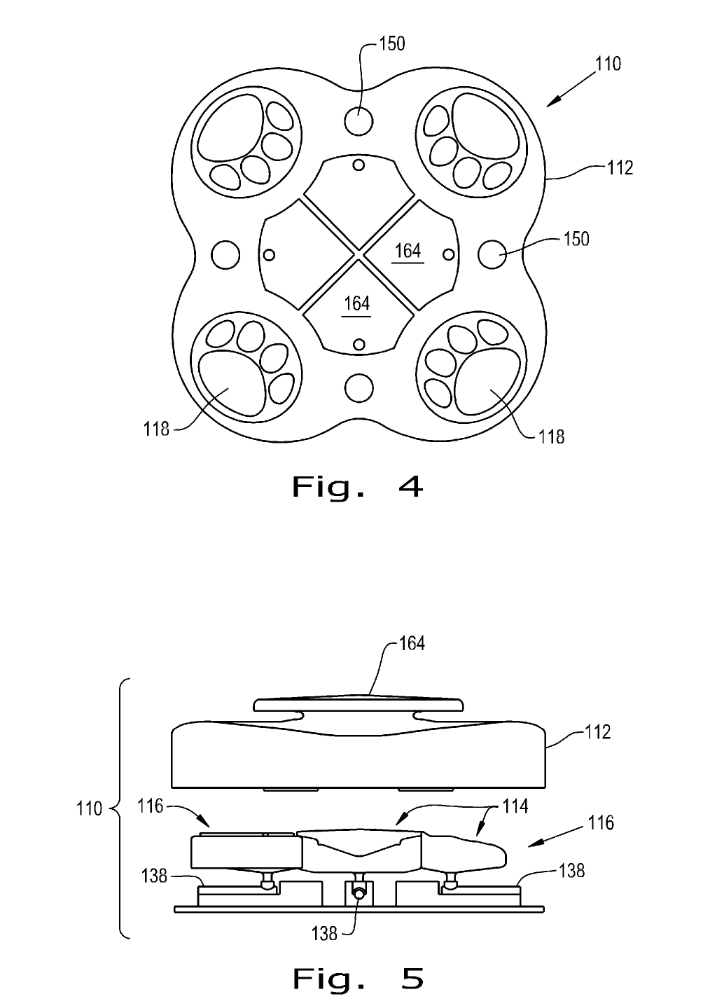

Function selector 150 may be a dial or another user interface device allowing the user to select among a variety of functions of shooting mechanism 116, such as treat velocity, distance, angle of elevation or even simpler terms such as near, moderate or far distances to determine the movement criteria for the selected treat. These items may also be selected by remote control 154 for each of shooting mechanisms 116. Additionally, controller 152 can be instructed to fire a shooting mechanism 116 that is not associated with the sensor 118 activation. For example, controller 152 may cause the left directed barrel 138 (of FIGS. 4 and 5) to fire when sensor 118 on the lower right of FIG. 4 is activated, instead of a barrel 138 that is closer to this sensor. Controller 152, can select which shooting mechanism 116 is to fire the treat based on a random selection, a sensed volume of treats in reservoir 114, a user defined sequence, a preselected pattern, an amount of power stored in battery 156, the isolation of a nonfunctioning shooting mechanism 116 or a training regime. Timing, including time delays, are also contemplated to be under the control of controller 152. It is also contemplated that one activation of one sensor 118 may cause several of the shooting mechanisms 116 to fire, or none at all, dependent upon the user selections made with function selectors 150 and/or remote control 154.

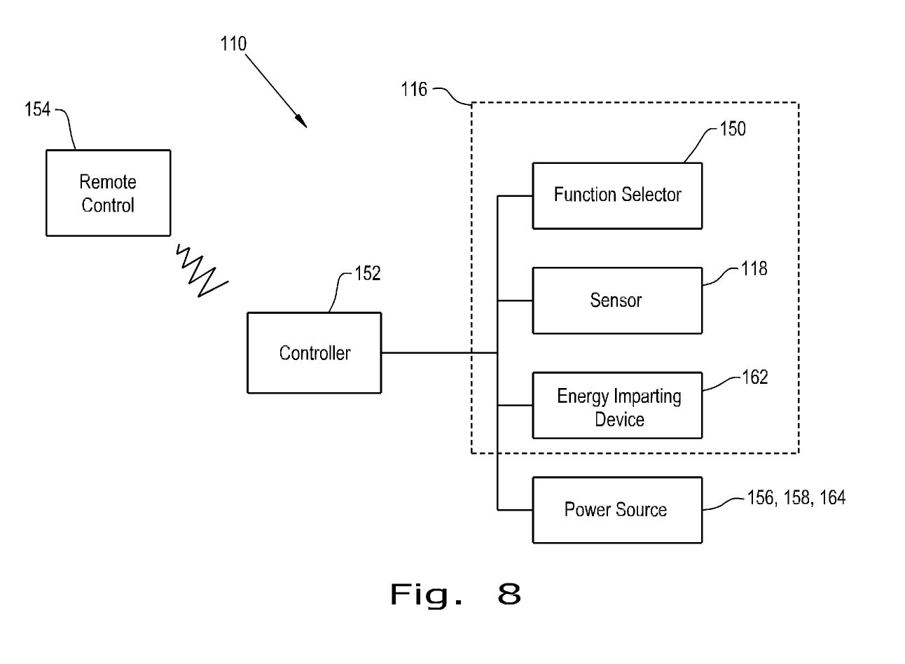

Power sources 156, 158 and 164, may individually power treat shooter 110, or they may do so in combination. For example solar cell 164 may provide power to battery 156 to charge battery 156 for later use by treat shooter 110. AC power connections 158, although shown for each of the modular shooting mechanisms 116 in FIG. 7, they may be daisy chained to an adjacent shooting mechanism 116 with only one AC power connection being coupled to an electrical receptacle (not shown). Although in FIG. 8, power source 156, 158, 164 is shown apart from shooting mechanism 116, it may be a part of them as illustrated in FIG. 7. FIG. 8 illustrates that power may be shared between shooting mechanisms 116, under control of controller 152.

Clean outs 160 allow access to the individual mechanisms to ensure that shooting mechanisms 116 remain functional and to unload treats that may be loaded in the shooting mechanisms 116. As shown in FIG. 5 housing 112 may be removed for the loading of treats into treat reservoirs 114. Controller 152 may be located in a portion of housing 112 with electrical interconnections between housing 112 and shooting mechanisms 116 not shown for the sake of clarity.

It is also contemplated to have sound and light feedback generated by treat dispenser 110 to help train or entertain a pet. The sound and/or light may be associated with the firing of treats or used as part of a training regimen. Portions of housing 112 may be translucent or transparent to allow light to pass therethrough.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A pet treat dispenser, comprising:
a housing having a treat chamber configured for containing a plurality of treats;
a power source;
a controller configured to issue a signal to release a treat; and
at least one shooting mechanism positioned substantially in said housing, said shooting mechanism being configured to sequentially shoot said treats from the dispenser, said at least one shooting mechanism including an energy imparting device coupled to said power source, said energy imparting device being configured to impart movement to a selected subset of said plurality of treats dependent upon receiving said signal from said controller.

2. The pet treat dispenser of claim 1, wherein said energy imparting device is an electrical device configured to produce movement in said selected subset of treats.

3. The pet treat dispenser of claim 2, wherein said treat chamber is configured to feed at least one of said plurality of treats to said energy imparting device.

4. The pet treat dispenser of claim 3, wherein said at least one shooting mechanism includes a barrel having an opening that extends through said housing, said barrel defining a treat path along which the treat travels upon leaving the pet treat dispenser.

5. The pet treat dispenser of claim 4, wherein each said at least one shooting mechanism includes a sensor, said sensor being in communication with said controller, said sensor being configured to sense one of a proximity and a touch of an animal.

6. The pet treat dispenser of claim 5, wherein said at least one shooting mechanism includes a first shooting mechanism and a second shooting mechanism coupled together.

7. The pet treat dispenser of claim 6, wherein said controller is configured to select either said barrel of said first shooting mechanism or said barrel of said second shooting mechanism upon receiving a signal from said sensor of said first shooting mechanism.

8. The pet treat dispenser of claim 7, wherein each said at least one shooting mechanism includes a function selector, said function selector in communication with said controller, said function selector sending information to said controller to alter a trajectory of said selected subset of treats.

9. The pet treat dispenser of claim 8, wherein said trajectory includes at least distance and angle of elevation of said selected subset of treats.

10. The pet treat dispenser of claim 9, further comprising a remote control in communication with said controller, said remote control being configured to at least one of alter said information from said function selector and fire a selected one of said first shooting mechanism and said second shooting mechanism.

11. A pet treat dispenser, comprising:
a power source;
a controller configured to issue a signal to release a treat; and
at least one shooting mechanism including an energy imparting device coupled to said power source, said energy imparting device being configured to impart movement to a selected treat dependent upon receiving said signal from said controller.

12. The pet treat dispenser of claim 11, wherein said energy imparting device is an electrical device configured to produce movement in said selected treat.

13. The pet treat dispenser of claim 12, further comprising a treat chamber configured to feed at least one treat to said energy imparting device.

14. The pet treat dispenser of claim 13, wherein said at least one shooting mechanism includes a barrel having an opening, said barrel defining a treat path along which the treat travels upon leaving the pet treat dispenser.

15. The pet treat dispenser of claim 14, wherein said at least one shooting mechanism includes a sensor, said sensor being in communication with said controller, said sensor being configured to sense one of a proximity and a touch of an animal.

16. The pet treat dispenser of claim 15, wherein said at least one shooting mechanism includes a first shooting mechanism and a second shooting mechanism coupled together.

17. The pet treat dispenser of claim 16, wherein said controller is configured to select either said barrel of said first shooting mechanism or said barrel of said second shooting mechanism upon receiving a signal from said sensor of said first shooting mechanism.

18. The pet treat dispenser of claim 17, wherein each said at least one shooting mechanism includes a function selector, said function selector being in communication with said controller, said function selector sending information to said controller to alter a trajectory of the selected treat.

19. The pet treat dispenser of claim 18, wherein said trajectory includes at least distance and angle of elevation of the selected treat.

20. The pet treat dispenser of claim 19, further comprising a remote control in communication with said controller, said remote control being configured to at least one of alter said information from said function selector and fire a selected one of said first shooting mechanism and said second shooting mechanism.
